(19) United States
(12) Patent Application Publication
(10) Pub. No.: US 2019/0032433 A1
(43) Pub. Date: Jan. 31, 2019

(54) Method for Collecting Geological Samples and Attitude-Controllable Work Apparatus

(71) Applicants: Topy Kogyo Kabushiki Kaisha, Tokyo (JP); Lapan Agency for Marine-Earth Science and Technology, Yokosuka-shi, Kanagawa (JP)

(72) Inventors: Takao Sawa, Yokosuka-shi, Kanagawa (JP); Tsuyoshi Horikiri, Tokyo (JP); Shingo Tsukui, Tokyo (JP)

(21) Appl. No.: 16/075,182

(22) PCT Filed: Feb. 23, 2017
(86) PCT No.: PCT/JP2017/006773

§ 371 Date: Aug. 3, 2018

(30) Foreign Application Priority Data
Feb. 26, 2016 (JP) 2016-035222

(51) Int. Cl. E21B 25/18; B62D 55/065; E21B 7/02

(52) U.S. Cl. CPC E21B 25/18; B62D 55/065; E21B 7/124; E21B 7/024; E21B 7/025

(57) ABSTRACT

A work apparatus that can collect core samples of a seabed ground at a desired angle in a stable manner includes a body 10, four flippers 30 rotatably disposed at left and right of a front section of the body 10 and at left and right of a rear section of the body 10 and a coring mechanism 20 disposed on the body 10 as basic features. An inclination sensor 17 that detects inclinations in a front-rear direction and in a left-right direction is disposed on the body 10. A load sensor 49 is attached to a support structure 40 rotatably supporting the flippers 30. A controller 16 controls rotations of the four flippers 30 based on information on inclination from the inclination sensor 17 and information on landing of the flippers 30 from the load sensor 49 to make the body 10 assume a desired attitude, which is a horizontal attitude, for example, and to land at least three flippers 30. After the attitude control, the controller 16 activates the coring mechanism 20 to collect the core samples from the seabed.

### FIELD OF THE INVENTION

The present invention relates to a method for collecting geological samples by coring a ground and to a work apparatus that performs works such as coring.

### BACKGROUND ART

It is known that the sea around Japan is rich in seabed mineral resources. However, the details are still unknown because such seabed mineral resources are distributed in broad sea areas.

Under the circumstance, detailed investigations into the distribution and the amount of resources of the seabed mineral resources are called for.

A geological sample collecting apparatus disclosed in Patent Document 1 (Japanese Unexamined Patent Application Publication No. 2005-155109) includes a body and a coring mechanism disposed in the body. The body is hoisted by a wire from a mother ship on the ocean and landed in a seabed, in which condition coring is performed. A plurality of altimeters are mounted on the collecting apparatus. Ultrasonic waves from the altimeters provide information on the seabed ground, which helps the body to land in a stable manner.

Patent Document 2 (Japanese Unexamined Patent Application Publication No. 2011-196140) discloses a detailed structure of an apparatus for collecting geological samples on land. This apparatus includes a coring mechanism in a front section of a body and a pair of crawlers at left and right of the body. The apparatus is moved to a destination by the crawlers and performs coring at the destination.

Patent Document 3 (Japanese Unexamined Patent Application Publication No. 2010-274669) discloses a seabed research robot including a thruster mounted in a body and four crawler-type flippers in total, respectively disposed at left and right of a front section of the body and at left and right of a rear section of the body. The robot can be moved to a destination by remote control from a mother ship and can collect seabed minerals with a robot hand or the like.

### SUMMARY OF THE INVENTION

### Problem to be Solved by the Invention

The geological sample collecting apparatus of the Patent Document 1 can collect geological samples (core samples) from under the seabed ground. However, it is required to land the apparatus on a flat seabed surface, and it is difficult to core inclined grounds such as a cobalt-rich crust and a hydrothermal deposit and markedly uneven grounds.

The geological sample collecting apparatus of the Patent Document 2 is intended for vertically coring a horizontal ground on land, and it is difficult to core inclined grounds and markedly uneven grounds.

It is also difficult for the geological sample collecting apparatus of the Patent Document 3 to work on inclined grounds and markedly uneven grounds. The apparatus can collect minerals exposed on the seabed. However, the apparatus cannot collect geological samples from under the ground.

### Solution to the Problem

To solve the problems mentioned above, the present invention provides a method for collecting geological samples including: preparing a geological sample collecting apparatus, the apparatus comprising a body, four flippers and a coring mechanism disposed on the body, the flippers rotatably disposed at left and right of a front section of the body and at left and right of a rear section of the body; landing at least three of the four flippers and making the body assume a desired attitude by rotating the four flippers; coring into the ground by the coring mechanism; and collecting the geological samples.

According to the method given above, even inclined or uneven grounds can be cored in a stable manner in a desired direction of coring by controlling rotation of the flippers, and geological samples can be collected from under the ground.

Preferably, a direction of coring by the coring mechanism is orthogonal to a plane on which rotational axes of the four flippers are disposed, and when the body is in the desired attitude, the plane is horizontal.

According to the method given above, even if the ground is inclined, coring can be performed in a vertical direction (direction of gravity).

In another aspect of the present invention, there is provided a work apparatus including: a body; four flippers rotatably disposed at left and right of a front section of the body and at left and right of a rear section of the body; an inclination sensor disposed on the body, the inclination sensor detecting inclination of the body in a front-rear direction and a left-right direction; landing sensors respectively detecting landing of the flippers; and a controller that controls rotation of the four flippers based on information on inclination from the inclination sensor and information on landing of the flippers from the landing sensors to land at least three of the flippers and have the body assume a desired attitude.

According to the features given above, even on inclined or uneven grounds, the body can be automatically made to take a stable desired attitude by controlling the rotation of the flippers based on the information from the inclination sensor and the landing sensor. As a result, work can be performed in a stable manner.

Preferably, the work apparatus further includes a coring mechanism disposed on the body for coring into the ground.

According to the features given above, the coring can be performed in a stable manner in the desired direction of coring, and geological samples can be collected from under the ground.

Preferably, a direction of coring by the coring mechanism is orthogonal to a plane on which rotational axes of the four flippers are disposed, and when the body is in the desired attitude, the plane is horizontal.

According to the features given above, even if the ground is inclined, coring can be performed in the vertical direction (direction of gravity).

Preferably, the landing sensor is a load sensor that detects load on a support structure for rotatably supporting the flippers with respect to the body.

According to the features given above, the landing sensor can be simplified.

Preferably, the load sensor is a strain gauge attached to the support structure. According to the features given above, the landing sensor can be further simplified.

Preferably, the controller controls rotation of the flippers to land all of the flippers.

According to the features given above, stability of the body can be further enhanced.

Preferably, the controller individually controls an inclination angle of the body in the front-rear direction and an inclination angle of the body in the left-right direction, when the controller controls the inclination angle of the body in the front-rear direction, the controller selects either the two flippers at a front side or the two flippers at a rear side and makes the selected flippers simultaneously rotated in a same direction, thereby controlling a height of the front section or the rear section of the body where the selected two flippers are disposed, thereby making the inclination angle of the body in the front-rear direction a first desired angle, and when the controller controls the inclination angle of the body in the left-right direction, the controller selects either the two flippers at a left side or the two flippers at a right side and makes the selected flippers simultaneously rotated in a same direction, thereby controlling a height of a left section or a right section of the body where the selected two flippers are disposed, thereby making the inclination angle of the body in the left-right direction a second desired angle.

According to the features given above, the inclination angle of the body in the front-rear direction and the inclination angle of the body in the left-right direction are individually controlled. Therefore, the control of the rotation of the flippers can be simplified. Moreover, in the control of the inclination angles, when the rotations of the selected two flippers are controlled, the two flippers that are not selected can be maintained in a landed state or a state near the landed state. Therefore, the inclination angles can be controlled in a stable manner.

Preferably, the controller individually controls an inclination angle of the body in the front-rear direction and an inclination angle of the body in the left-right direction, when the controller reduces the inclination angle of the body in the front-rear direction, the controller selects either the two flippers at a front side or the two flippers at a rear side that are positioned lower and makes the selected flippers simultaneously rotated downward, thereby lifting the front section or the rear section of the body where the selected two flippers are disposed, and when the controller reduces the inclination angle of the body in the left-right direction, the controller selects either the two flippers at a left side or the two flippers at a right side that are positioned lower and makes the selected flippers simultaneously rotated downward, thereby lifting a left section or a right section of the body where the selected two flippers are disposed.

According to the features given above, a control for making the body horizontal can be simplified, and at the same time the inclination angle can be securely reduced.

Preferably, the controller firstly lifts all the flippers through a predetermined angle to make basal end sections of the flippers at rotational axes sides landed, and the controller makes the body horizontal from this initial state by rotating the selected flippers downward.

According to the features given above, the body can be made horizontal efficiently.

Preferably, the body includes an underwater mobile device.

According to the features given above, in a mineral resource survey in the seabed, for example, the collecting apparatus can be moved to a planned collection site or a neighborhood thereof by the underwater vehicle. Therefore, many spots can be efficiently surveyed.

Preferably, the flipper includes a drive wheel disposed in a basal end section of the flipper at a rotational axis side, an idler wheel disposed in a distal end section of the flipper and a continuous track laid around the drive wheel and the idler wheel.

According to the features given above, in a mineral resource survey in the seabed, for example, after moving the collecting apparatus to a neighborhood of a planned collection site by the underwater vehicle, the apparatus can be accurately moved to the planned collection site by driving the flippers.

### Advantageous Effects of the Invention

According to the present invention, even in irregular or inclined grounds such as seabed, an attitude of a work apparatus such as a geological sample collecting apparatus can be made stable.

### BRIEF DESCRIPTION OF THE DRAWINGS

FIG. 1 is a schematic side view of a geological sample collecting apparatus according to a first embodiment of the present invention, shown with flippers retracted.

FIG. 2 is a schematic side view of the collecting apparatus, shown with the flippers extended.

FIG. 3 is a schematic side view of the collecting apparatus, shown on an inclined ground.

FIG. 4 is a schematic side view of the collecting apparatus in a state in which attitude thereof is controlled.

FIG. 5 is a schematic plan view of the collecting apparatus, shown with an underwater mobile device in an upper section omitted.

FIG. 6 is a schematic front view of the collecting apparatus.

FIG. 7 is an enlarged side view of a major section of the collecting apparatus.

FIG. 8 is an enlarged plan view of the major section of the collecting apparatus, partially showing a cross-section thereof.

FIG. 9 is an enlarged front view of the major section of the collecting apparatus, partially showing a cross-section thereof.

FIG. 10 is a flow chart of an attitude control performed before coring starts.

FIG. 11 is schematic side view of a geological sample collecting apparatus according to a second embodiment of the present invention, shown with flippers extended.

### DESCRIPTION OF THE PREFERRED EMBODIMENTS

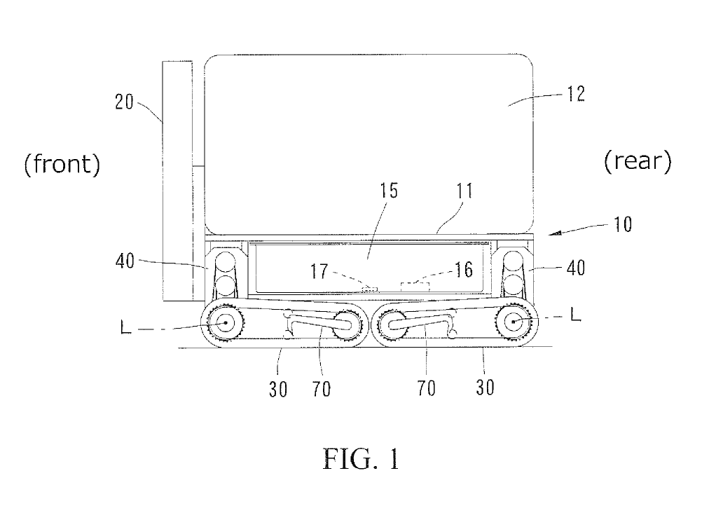

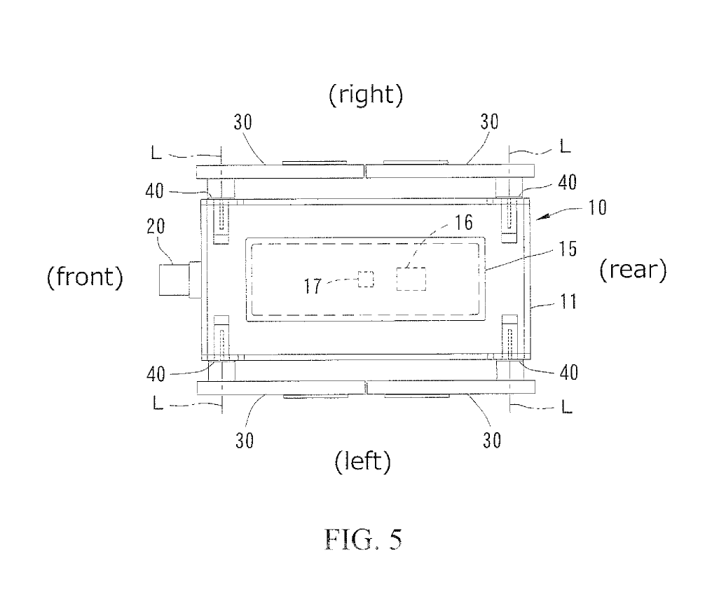

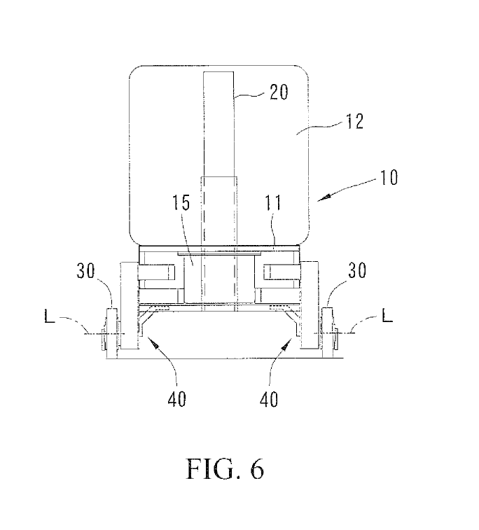

An apparatus for collecting geological samples of a seabed ground (work apparatus) according to a first embodiment of the present invention will be described hereinafter with reference to FIGS. 1 to 10. In order to facilitate understanding, front-rear and left-right directions are indicated in FIGS. 1 and 5.

As shown in FIGS. 1, 5 and 6, the collecting apparatus includes a body 10, a coring mechanism 20 and four crawler-type flippers 30 (hereinafter referred to as “flippers”) as main components.

The body 10 includes a base 11 having a rectangular planar shape and an underwater mobile device 12 fixed to a top surface of the base 11.

The underwater mobile device 12 is what is called ROV (Remotely Operated Vehicle) and is of a known structure, and therefore detailed description thereof is omitted. The underwater mobile device 12 includes horizontal thrusters each composed of a pair of left and right propellers or the like in a front section and a rear section of a frame and two vertical thrusters respectively disposed at left and right of the frame. The number and arrangement of the horizontal thrusters and the vertical thrusters can be selected according to the ROV.

A video camera (not shown) is disposed in a front section of the frame of the underwater mobile device 12. The number of the video camera may be one or alternatively, plural so that three-dimensional videos may be obtained.

A sealed box 15 is fixed to the base 11 of the body 10. A transceiver (not shown), a controller 16 including a microcomputer, a motor driver or the like and a gyroscope sensor 17 (inclination sensor) or the like are received in the box 15. In place of the gyroscope sensor 17, a gyroscope sensor mounted on the ROV may be used.

The controller 16 is operated through communication commands sent from a maneuvering device on a mother ship side via a cable (not shown) and the transceiver. The controller 16 performs an attitude control by controlling the thrusters of the underwater mobile device 12, controlling the movement of the flippers 30 and swinging (rotating) the flippers 30 as described later. Through the cable, power is supplied from the mother ship to the collecting apparatus.

The gyroscope sensor 17 detects inclinations of the base 11 of the body 10 (more specifically, inclination of a planar surface on which rotational axes L of the four flippers 30 to be described later lie) in the front-rear direction and the left-right direction.

The coring mechanism 20 is fixed to a center of a front section of the base 11. The coring mechanism 20 is of a known structure, and therefore is schematically depicted in the drawings. To describe it simply, the coring mechanism 20 has a double-cylindrical structure composed of a drilling cylinder on an outer side and a retaining cylinder on an inner side. The retaining cylinder is supported such that the retaining cylinder is not movable in an axial direction but rotatable with respect to the drilling cylinder. The drilling cylinder is moved downward and rotationally driven to make a drill bit disposed on a lower end of the drilling cylinder drill the ground to form a deep annular ditch having a circular configuration. After that, the drilling cylinder and the retaining cylinder are pulled up, and thereby, a core sample (geological sample) having a columnar configuration left inside the annular ditch can be collected while being retained in the retaining cylinder. The coring mechanism 20 is not limited to the one of the known structure as mentioned above, and various modifications may be made thereto. For example, when a core sample is hard, a function to bend the core sample may be added. The drilling cylinder and the retaining cylinder may be secured to different lifting and lowering devices, and after the core sample is drilled by the drilling cylinder, the core sample may be lifted by the retaining cylinder.

A direction of coring by the coring mechanism 20 is orthogonal to the base 11 (the planar surface on which the rotational axes L of the four flippers 30 lie).

The four flippers 30 mentioned above are supported by support structures 40 at the left and right of the front section of the base 11 and at the left and right of a rear section of the base 11 such that the flippers 30 are rotatable (swingable) about the rotational axes L.

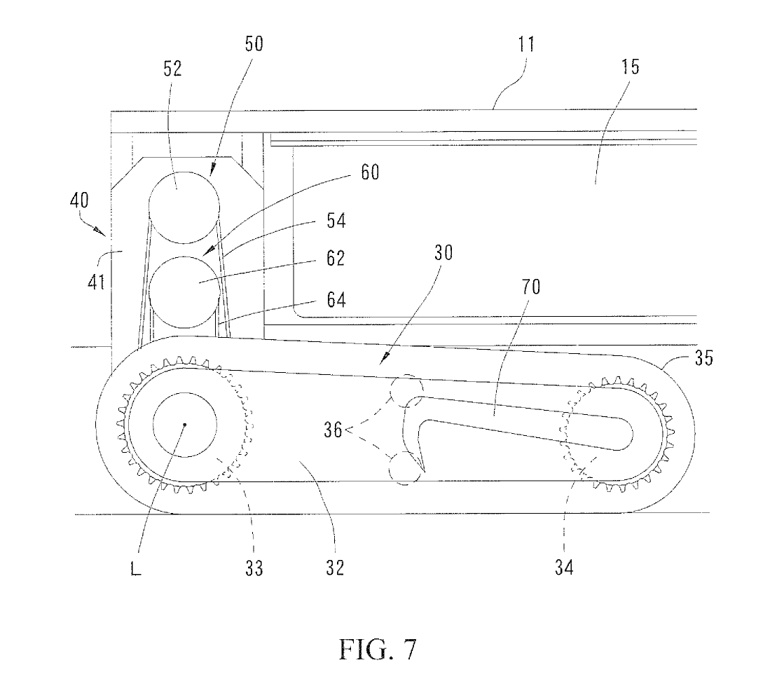

As shown in FIGS. 7 to 9, each of the flippers 30 includes a pair of elongated side plates 31, 32 disposed parallel to each other and connected to each other, a drive sprocket wheel 33 (to be referred to as a “drive wheel” hereinafter) disposed between basal end sections (end sections on the rotational axes L side) of the side plates 31, 32, an idler sprocket wheel 34 (to be referred to as an “idler wheel” hereinafter) disposed between distal end sections of the side plates 31, 32, a continuous track 35 laid around the wheels 33, 34 and track rollers 36 disposed in the side plates 31, 32 to support the continuous track 35.

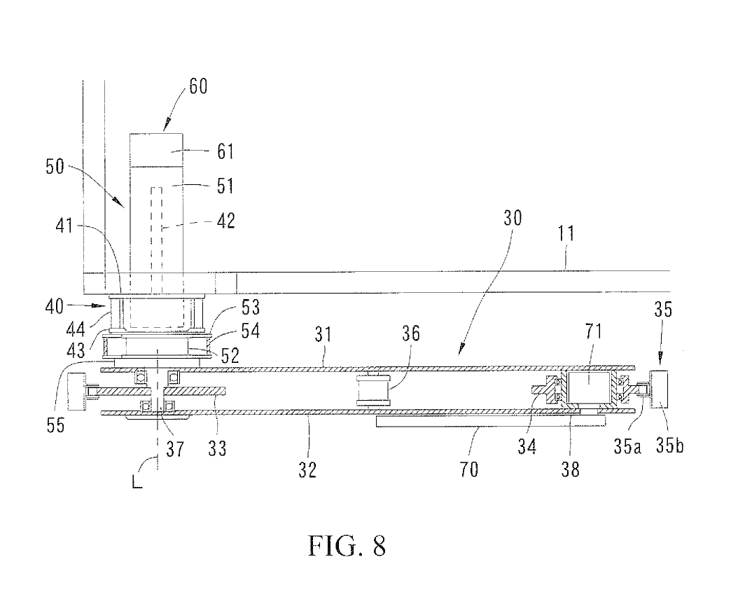

As shown in FIG. 8, the drive wheel 33 is fixed to a shaft 37 that is arranged coaxially with the rotational axis L and receives torque via the shaft 37 as described later. The shaft 37 is rotatably supported by the basal end sections of the side plates 31, 32. The idler wheel 34 is rotatably supported by a hollow shaft member 38 fixed to the distal end sections of the side plates 31, 32.

As shown in FIG. 8, the continuous track 35 includes a chain 35a and ground-contacting lugs 35b fixed to an outer periphery of the chain 35a at equal intervals. In other drawings, the continuous track 35 is depicted in a simplified manner.

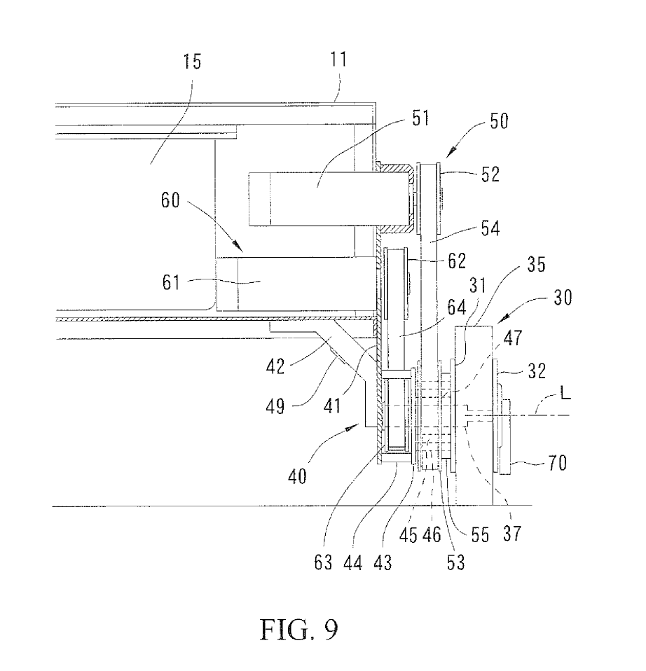

Next, the support structures 40 rotatably (swingably) supporting the flippers 30 are described in detail with reference to FIGS. 8 and 9. The support structure 40 includes a support plate 41 fixed to a side surface of the base 11 and vertically extending downward, a reinforcement bracket 42 fixedly laid between an inner surface of a lower section of the support plate 41 and an under surface of the base 11, an auxiliary plate 43 disposed parallel to and spacedly opposed to an outer surface of the lower section of the support plate 41, a plurality of spacers 44 having a pin configuration and fixing the auxiliary plate 43 to the support plate 41 and a support cylinder 45 fixed to an outer surface of the auxiliary plate 43 and having a circular cylindrical configuration. The support cylinder 45 is disposed coaxially with the rotational axis L.

A strain gauge 49 (landing sensor, load sensor) is attached to the bracket 42.

A drive mechanism 50 for swinging the flippers 30 includes a motor 51, a pulley 52 fixed to an output shaft of the motor 51, a pulley 53 located below the pulley 52, a belt 54 laid around the pulleys 52, 53, and a ring-shaped spacer 55 that fixes the lower pulley 53 to the inner side plate 31 of the flipper 30. The pulley 53 and the spacer 55 are coaxial with the rotational axis L.

The support cylinder 45 of the support structure 40 rotatably supports the pulley 53 and the spacer 55 via a bush 46, thereby supporting the entirety of the flipper 30 such that the flipper 30 is rotatable about the rotational axis L.

Moreover, the support cylinder 45 rotatably supports the shaft 37 via a bearing 47, thereby rotatably supporting the drive wheel 33.

A drive mechanism 60 for rotationally driving the drive wheels 33 of the flippers 30 includes a motor 61, a pulley 62 fixed to an output shaft of the motor 61, a pulley 63 located below the pulley 62, a belt 64 laid around the pulleys 62, 63. The lower pulley 63 is fixed to the shaft 37.

A hook 70 is disposed on the flipper 30 in this embodiment. To describe it simply, a motor 71 is received in the hollow shaft member 38 of the flipper 30. An output shaft of the motor 71 is protruded passing through the outer side plate 32 and one end of the hook 70 is fixed to the output shaft. The hook 70 is located at a position where the hook 70 is not protruded from outer peripheries of the side plates 31, 32 under normal conditions.

The collecting apparatus having the features mentioned above is used for collecting geological samples from under abyssal seabed grounds. An operator on the mother ship remotely operates the maneuvering device, monitoring videos from the video camera of the collecting apparatus to drive the thrusters of the underwater mobile device 12, thereby moving the collecting apparatus under the sea to land the collecting apparatus in a neighborhood of a destination on the seabed. During the movement, the crawler-type flippers 30 are in retracted positions as shown in FIG. 1. Specifically, the flippers 30 at the front are folded backward and the flippers 30 at the rear are folded forward.

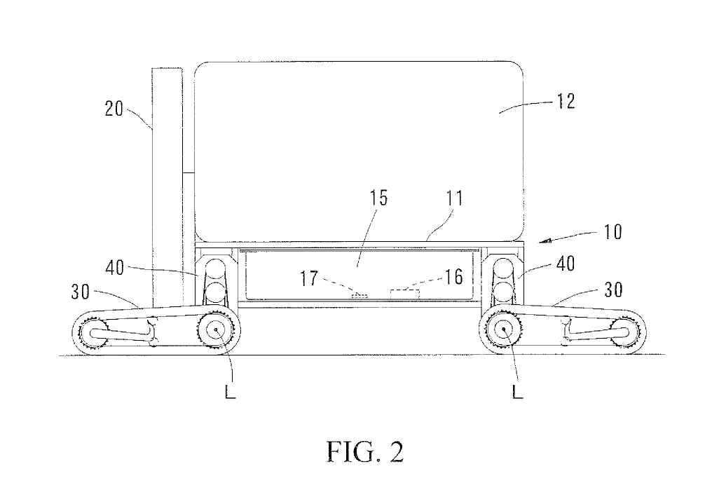

Next, the flippers 30 are moved to extended positions as shown in FIG. 2. Specifically, the flippers 30 at the front are driven by the motors 51 to be turned about 180 degrees from the state shown in FIG. 1 to extend forward. The flippers 30 at the rear are driven by the motors 51 to be turned about 180 degrees from the state shown in FIG. 1 to extend backward.

With the flippers 30 in the extended positions, the motors 61 of the respective flippers 30 shown in FIGS. 7 and 8 are driven to rotate the drive wheels 33. Thereby, the continuous tracks 35 are moved, and thus the collecting apparatus is moved to the destination. Since the flippers 30 are extended as mentioned above, the collecting apparatus can be moved to the destination in a stable manner.

Each of the flippers 30 can be moved forward and rearward independent from each other. As a result, the body 10 can make a turn as well as move forward and rearward.

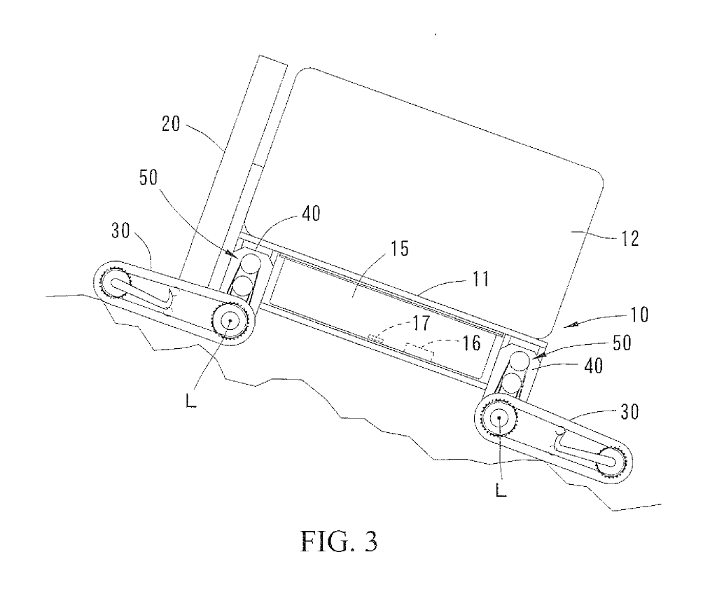

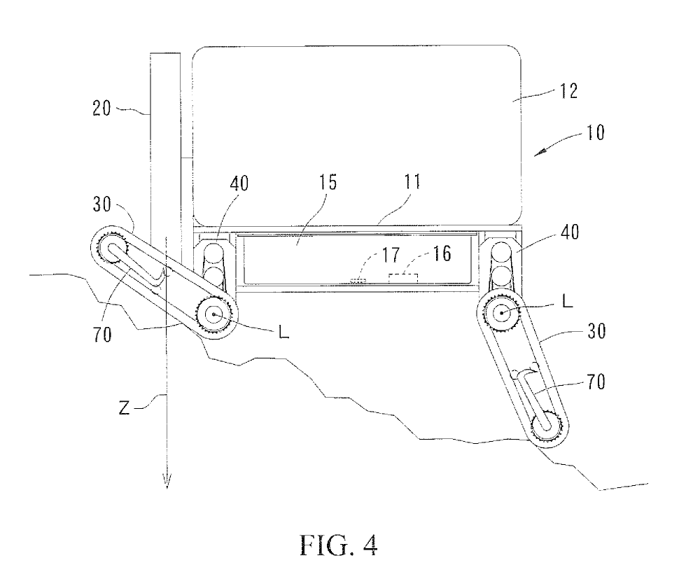

After the collecting apparatus reaches the destination as shown in FIG. 3, the controller 16 controls the attitude of the collecting apparatus by driving the motors 51 (refer to FIGS. 8 and 9) of the drive mechanisms 50 of the four flippers 30 to rotate the flippers 30 about the rotational axes L in response to command signals from the maneuvering device on the mother ship. By the attitude control, the base 11 of the body 10 can be made to assume a desired attitude, for example horizontal as shown in FIG. 4, even when the collecting apparatus is on an inclined section of a lifted ground.

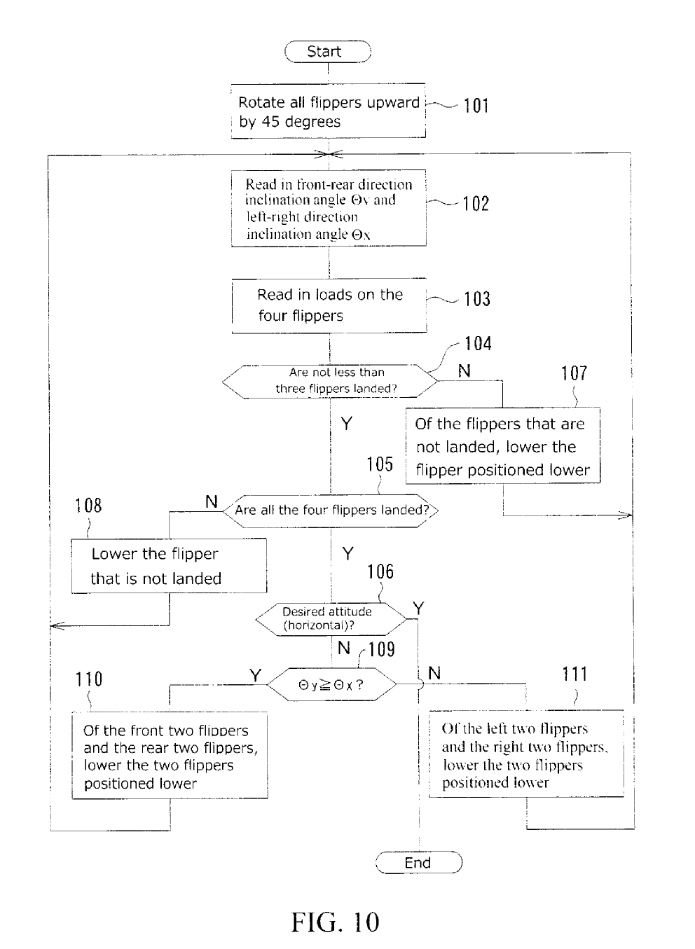

The attitude control performed by the controller 16 is explained hereinafter with reference to FIG. 10.

In Step 101, all the flippers 30 are rotated to a predetermined angle, for example 45 degrees upward. Thereby, distal end sections of all the flippers 30 are separated from the ground. If the ground is not level, not all the flippers 30 may be landed with basal end sections thereof on the ground. However, the basal end sections of at least two of the flippers 30 are landed.

Next, an inclination angle Θy in the front-rear direction and an inclination angle Θx in the left-right direction are read in from output of the gyroscope sensor 17 (Step 102) and distortions of the support structures 40 of the four flippers 30, that is information on loads on the support structures 40 are read in from output of the strain gauge 49 (Step 103).

Next, a judgment is made whether not less than three flippers 30 are landed (Step 104). When a load on each of the flippers 30 is not less than a threshold value, it is judged that the flipper 30 is landed. The threshold value may be a relatively small value.

If the judgement is positive in Step 104, a judgment is made whether all of the four flippers 30 are landed (Step 105). If the judgment is positive, a judgment is made whether the base 11 is horizontal or not (Step 106). If the judgment is positive, the attitude control is ended.

However, in a condition where the collecting apparatus is on a lifted ground and all the flippers 30 are lifted, it rarely happens that the basal end sections of all of the four flippers 30 are landed and the base 11 is horizontal. In practice, a negative judgment may be made in at least one of Steps 104, 105 and 106.

If the judgment is negative in Step 104, that is if it is judged that only two of the flippers 30 are landed, the process proceeds to Step 107, and of the two flippers 30 that are not landed, the flipper 30 positioned lower is rotated downward. A vertical positional relationship of the two flippers 30 can be judged based on information on the inclination angles Θy and Θx. As mentioned above, when the flipper 30 that is not landed is lowered, the distal end section of the flipper 30 is landed. In Step 107, the flipper 30 is lowered little by little and the process goes back to Step 102. Steps 102, 103, 104 and 107 are repeated until the flipper 30 is landed.

When the flipper 30 positioned lower is landed in this manner, a positive judgment is made in Step 104, and the process proceeds to Step 105.

If the judgment is negative in Step 105, that is if judgment is made that the three of the flippers 30 are landed and the one of the flippers 30 is not landed, the process proceeds to Step 108. In Step 108, the flipper 30 that is not landed is lowered, and the process goes back to Step 102. Thereby, in the similar manner to the above, the distal end section of the flipper 30 that is not landed can be landed.

When all of the flippers 30 are landed, a positive judgment is made in Step 105, and the process proceeds to Step 106. When a judgment is negative in Step 106, that is when it is judged that the base 11 is not horizontal, the process proceeds to Step 109, where an inclination angle Θy of the base 11 in the front-rear direction is compared with an inclination angle Θx of the base 11 in the left-right direction.

If it is judged in Step 109 that Θx is equal to Θy or that the inclination angle Θy is greater than Θx, the process proceeds to Step 110. In step 110, of the two flippers 30 at a front and the two flippers 30 at a rear, the two flippers 30 that are positioned lower in the front-rear direction are simultaneously lowered. For example, if the base 11 is inclined such that the rear side thereof is lower, the two flippers at the rear are simultaneously lowered. As a result, a lower section of the base 11 in the inclination in the front-rear direction is lifted, and the inclination angle Θy in the front-rear direction is reduced. During this time, the inclination angle Θx in the left-right direction is generally unchanged. Therefore, the two flippers 30 that are not rotationally controlled, that is the two flippers 30 at the front or at the rear located in a higher side of the inclination can be generally maintained in a landed state, thereby the attitude control can be performed in a stable manner.

If it is judged in Step 109 that the inclination angle Θx in the left-right direction is greater than Θy, the process proceeds to Step 111. In step 111, of the two flippers 30 at a left side and the two flippers 30 at a right side, the two flippers 30 that are positioned lower in the left-right direction are simultaneously lowered. As a result, a lower section of the base 11 in the left-right direction is lifted, and the inclination angle Θx in the left-right direction is reduced. During this time, the inclination angle Θy in the front-rear direction is generally unchanged. Therefore, the two flippers 30 that are not rotationally controlled can be generally maintained in a landed state.

As mentioned above, even if the body 10 is inclined in the front-rear direction and/or in the left-right direction, the inclination angle can be gradually reduced by rotationally controlling the flippers 30, and eventually the body 10 can be made horizontal, thus the attitude control can be ended.

In this embodiment, of the inclinations in the front-rear direction and the left-right direction, the inclination in the direction having a larger inclination angle is reduced first. After the inclination angles in the front-rear direction and the left-right direction become generally the same, the inclinations are alternately reduced little by little. Therefore, the attitude control can be performed in a further stable manner.

After the attitude of the base 11 is made horizontal as mentioned above, in response to coring commands from the maneuvering device on the mother ship, the controller 16 moves the coring mechanism 20 to collect the core sample (geological sample). Since the base 11 is horizontal at this time, the coring direction (direction Z in FIG. 4) can be a vertical direction (direction of gravity).

In this embodiment, the flippers 30 respectively include the hooks 70. Since the hooks 70 can be rotated to be engaged with concavities or convexities of the ground, producing an anchor effect, levitation of the body 10 due to a reaction force during the coring can be constrained. Thereby, the coring can be surely performed.

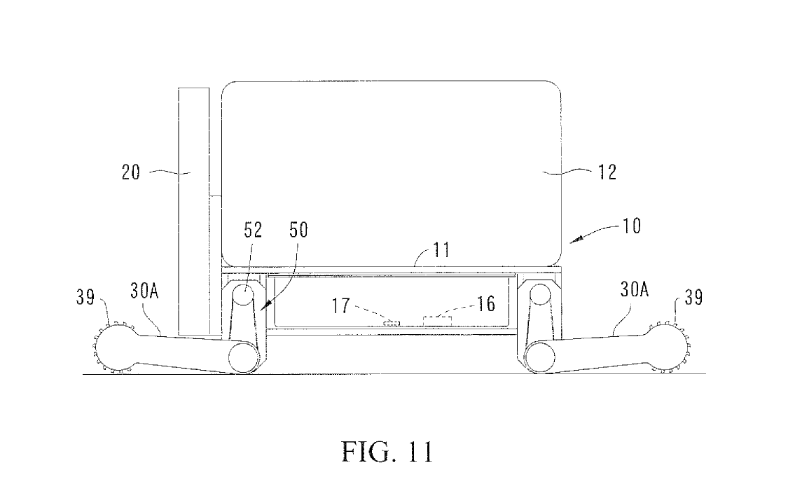

A collecting apparatus according to a second embodiment will be described hereinafter with reference to FIG. 11. In the description of the second embodiment, same reference numerals will be used to indicate features corresponding to those of the first embodiment, and explanation thereof will be omitted. In the second embodiment, the flippers 30A are made of single elongated plate materials and do not possess a moving function not like the crawler-type flippers of the first embodiment. A distal end of the flipper 30A has a circular configuration and protrusions 39 are integrally or separately formed in an outer periphery thereof.

The collecting apparatus of the second embodiment includes a drive mechanism 50 that makes the flippers 30A swing, but does not include the drive mechanism 60 of the first embodiment. Attitude control is performed in a similar manner to the first embodiment.

The present invention is not limited to the embodiments described above, and various modifications can be adopted.

In the embodiments shown in the drawings, when the collecting apparatus is viewed from above, the four flippers are disposed out of the body to the left and to the right. However, the flippers may be disposed so as to be hidden behind the body.

In the attitude control, instead of landing all of the four flippers, at least three flippers may be landed.

Since an angle correctable by the attitude control is limited by a length and a width of the body and a length of the flipper or the like, a predetermined angle range with respect to the horizontal attitude may be allowed.

The desired attitude (target attitude) of the attitude control includes not only the base being horizontal but also at a predetermined inclination angle. In the latter case, for the attitude control, the flipper may be rotated not only downward but also upward.

The underwater mobile device (ROV) can be used to change destination when the ground is so steeply inclined that the attitude control cannot be performed. Moreover, the ROV may be used more proactively. For example, when the ground is steeply inclined (including vertical inclination), the vertical thruster of the ROV may be driven to push the flippers against the ground, and in this condition, the attitude control may be performed.

The role of an attitude control may be assumed by the maneuvering device on the mother ship.

The coring mechanism may be disposed at the rear of the base or the ROV or may be disposed at the left or the right of the base or the ROV.

A rotation mechanism may be disposed between connecting sections of the base and the ROV as with a construction machine for use on land. In this case, the ROV and the coring mechanism disposed on the ROV can be turned without moving the base and the flippers.

The collecting apparatus of the present invention can also be used for collecting geological samples on land.

The ground may be a mountain formed by deposition of wastes. The attitude control may be performed not only for coring but also while running to move. In the latter case, stable running can be performed by always contacting the ground at not less than three points.

The apparatus of the present invention may be applied to an apparatus for collecting geological samples such as mineral agglomerates without coring or to a work apparatus for works other than collecting geological samples.

### INDUSTRIAL APPLICABILITY

The present invention may be applied to a collecting apparatus for collecting geological samples or the like.

1. A method for collecting geological samples comprising:
preparing a geological sample collecting apparatus, the apparatus comprising a body, four flippers and a coring mechanism disposed on the body, the flippers rotatably disposed at left and right of a front section of the body and at left and right of a rear section of the body;
landing at least three of the four flippers and making the body assume a desired attitude by rotating the four flippers;
coring into the ground by the coring mechanism; and
collecting the geological samples.

2. The method for collecting geological samples according to claim 1, wherein a direction of coring by the coring mechanism is orthogonal to a plane on which rotational axes of the four flippers are disposed, and when the body is in the desired attitude, the plane is horizontal.

3. A work apparatus comprising:
a body;
four flippers rotatably disposed at left and right of a front section of the body and at left and right of a rear section of the body;
an inclination sensor disposed on the body, the inclination sensor detecting inclination of the body in a front-rear direction and a left-right direction;
landing sensors respectively detecting landing of the flippers; and
a controller that controls rotation of the four flippers based on information on inclination from the inclination sensor and information on landing of the flippers from the landing sensors to land at least three of the flippers and have the body assume a desired attitude.

4. The work apparatus according to claim 3, further comprising a coring mechanism disposed on the body for coring into the ground.

5. The work apparatus according to claim 4, wherein a direction of coring by the coring mechanism is orthogonal to a plane on which rotational axes of the four flippers are disposed, and when the body is in the desired attitude, the plane is horizontal.

6. The work apparatus according to claim 3, wherein the landing sensor is a load sensor that detects load on a support structure for rotatably supporting the flippers with respect to the body.

7. The work apparatus according to claim 6, wherein the load sensor is a strain gauge attached to the support structure.

8. The work apparatus according to claim 3, wherein the controller controls rotation of the flippers to land all of the flippers.

9. The work apparatus according to claim 3, wherein the controller individually controls an inclination angle of the body in the front-rear direction and an inclination angle of the body in the left-right direction,
when the controller controls the inclination angle of the body in the front-rear direction, the controller selects either the two flippers at a front side or the two flippers at a rear side and makes the selected flippers simultaneously rotated in a same direction, thereby controlling a height of the front section or the rear section of the body where the selected two flippers are disposed, thereby making the inclination angle of the body in the front-rear direction a first desired angle, and
when the controller controls the inclination angle of the body in the left-right direction, the controller selects either the two flippers at a left side or the two flippers at a right side and makes the selected flippers simultaneously rotated in a same direction, thereby controlling a height of a left section or a right section of the body where the selected two flippers are disposed, thereby making the inclination angle of the body in the left-right direction a second desired angle.

10. The work apparatus according to claim 3, wherein the controller individually controls an inclination angle of the body in the front-rear direction and an inclination angle of the body in the left-right direction,
when the controller reduces the inclination angle of the body in the front-rear direction, the controller selects either the two flippers at a front side or the two flippers at a rear side that are positioned lower and makes the selected flippers simultaneously rotated downward, thereby lifting the front section or the rear section of the body where the selected two flippers are disposed, and
when the controller reduces the inclination angle of the body in the left-right direction, the controller selects either the two flippers at a left side or the two flippers at a right side that are positioned lower and makes the selected flippers simultaneously rotated downward, thereby lifting a left section or a right section of the body where the selected two flippers are disposed.

11. The work apparatus according to claim 10, wherein the controller firstly lifts all the flippers through a predetermined angle to make basal end sections of the flippers at rotational axes sides landed, and
the controller makes the body horizontal from this initial state by rotating the selected flippers downward.

12. The work apparatus according to claim 3, wherein the body comprises an underwater mobile device.

13. The work apparatus according to claim 3, wherein the flipper comprises a drive wheel disposed in a basal end section of the flipper at a rotational axis side, an idler wheel disposed in a distal end section of the flipper and a continuous track laid around the drive wheel and the idler wheel.
